(19) United States
(12) Patent Application Publication
(10) Pub. No.: US 2023/0042209 A1
(43) Pub. Date: Feb. 9, 2023

(54) Tag Element System for User Content

(71) Applicant: Wildflower Ventures, LLC, Raleigh, NC (US)

(72) Inventors: Venus Liles, Raleigh, NC (US); Samuel Weaver, Wilmington, NC (US)

(21) Appl. No.: 17/397,597

(22) Filed: Aug. 9, 2021

(51) Int. Cl. G06F 16/955; G06K 19/06; G06K 19/07; G06K 7/14; G06K 7/10

(52) U.S. Cl. CPC G06F 16/9554; G06K 19/06037; G06K 19/0723; G06K 7/1417; G06K 7/10366; G06K 7/10297

(57) ABSTRACT

The Tag Element System allows users to create, upload, and share virtual content in the physical world utilizing the Tag Element System platform, “Enhanced Tag Elements”, and a smart device such as a smartphone or tablet. Any user can record a video or create other content and attach it to an Enhanced Tag Element simply by scanning or otherwise interacting with it with their smart device. The system provides a user interface to enable a user to create and upload new content upload previously stored content to the Tag Element System. Once content is uploaded, the user can share the Enhanced Tag Element with another user to allow that user to access, modify, and/or interact with the content.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Tag elements such as QR codes are in common use and permit a user to scan the QR code to access the information, whether directly attached to or accessed through an embedded link, that is associated with the QR code. Typically, a tag element may be considered an opening into a data store or data interaction for a user to gather information, update a view within a browser, or provide for other data interactions for the edification of the user that scans the QR code. QR codes, and other tag elements, are typically generated by a service provider, business, or other provider to permit access by a user. However, data interaction with a QR code is not generally considered to be modifiable by a user accessing the code or tag element.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of an exemplary Enhanced Tag Element consistent with certain embodiments of the present invention.

FIG. 2 is a view of the Tag Element System architecture consistent with certain embodiments of the present invention.

FIG. 3 is a flow diagram view of the process for user interaction with an Enhanced Tag Element consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Tag elements, such as QR codes, NFC tags, RFID tags, or other such tag elements provide an ability for a user to scan and/or interact with the tag and receive information associated with the tag or be provided with a link to another source of information. Tag elements provide this direct link to other information or transmission to a site that provides information or an application for use. Tag elements typically do not provide users the ability to upload new content or modify current content after the tag element is created (hereinafter referred to as “Naive Tag Elements”).

There is a need to provide users with the ability to upload and associate with an existing tag element user created content that differs from the content previously associated with the tag element and/or is created after the tag element is created. In this embodiment, the tag element (whether expressed in a physical or digital medium) does not change but does permit the creation and/or modification of content associated with the tag element (hereinafter referred to as “Enhanced Tag Elements”).

The “Tag Element System” is a cloud-based platform that permits the creation and upload of user-generated content to Enhanced Tag Elements pre-generated by the system from either a web-based GUI or from a mobile application. The user-generated content may be associated with an Enhanced Tag Element without changing the tag element identifier, but changing the information, location, or experience that the user may experience upon scanning the Enhanced Tag Element. In this embodiment, an Enhanced Tag Element, with appropriate identifier, may be generated and provided to a user. The user may then scan the Enhanced Tag Element which may provide access to the user to the Tag Element System. Thus, an original user may scan a created Enhanced Tag Element and be directed to the Tag Element System. The Tag Element System, upon determining that there is no user content to which to direct the user who has scanned the Enhanced Tag Element, may permit the user to create and/or upload user content in various forms that may be saved to the Tag Element System and provided to a subsequent user that scans the same Enhanced Tag Element. The Tag Element System and method are herein further described.

In this innovation the Tag Element System software platform enables the repurposing of an Enhanced Tag Element to which user content has been uploaded. The initial recipient of a pre-generated Enhanced Tag Element will be able to upload content to the pre-generated Enhanced Tag Element and thereby designate that the destination of the Enhanced Tag Element is then defined by the user uploaded content such that the next recipient of the Enhanced Tag Element is directed to the destination and/or content uploaded by the previous user. In this manner the Enhanced Tag Element is redirected by a user to a different destination or content for the next user.

In this innovation the software will also enable the future repurposing of an Enhanced Tag Element to which user content has been previously uploaded. A subsequent recipient of a pre-generated Enhanced Tag Element may be able to upload additional user-generated content to the Enhanced Tag Element to append to or replace existing content, thereby designating that the destination of the Enhanced Tag Element is now defined by the additional user uploaded content such that the next recipient of the Enhanced Tag Element is directed to the destination and/or content uploaded by the previous user(s). In this manner the Enhanced Tag Element may be redirected by a recipient user to a different destination or content for the next user.

In an embodiment, the Tag Element System allows users to create and upload virtual content that is later communicated to another user in connection with a physical interaction. One example is an owner or manager of short-term rental properties creating an instructional video for a coffee maker that can later be viewed by a guest by scanning a QR code associated with an Enhanced Tag Element. Another example is a parent attaching an audio message to an NFC tag inside a teddy bear (to the extent that the NFC tag has been associated with an Enhanced Tag Element) before giving it to a child as a gift.

The Tag Element System is unique because it allows users to create, upload, and share virtual content with only the Tag Element System platform and their device (e.g., a smartphone or tablet). Any user with a smartphone capable of reading tag elements can generate content and attach it to an Enhanced Tag Element simply by scanning or otherwise interacting with it. The user does not need to have the content created and available on the Internet in advance (like on YouTube® or a website). The current version of the Tag Element System does not even require the user to download a mobile application. Additionally, users' devices do not need to be capable of producing or writing to tag elements; users can add content to the Enhanced Tag Element without changing the information attached to the tag element (whether the pre-generated tag element is expressed in a physical or digital medium). The Tag Element System enables this capability; this functionality is not possible using Naive Tag Elements.

The Tag Element System consists of two main components: the cloud infrastructure and the Enhanced Tag Elements. The cloud infrastructure generates a unique URL for each Enhanced Tag Element. The URL is accessible via a tag element (such as but not limited to a QR code or an NFC tag), expressed in a physical or digital medium. By the nature of the tag element containing a URL to the Tag Element System, it may be considered an Enhanced Tag Element. Then, when that Enhanced Tag Element is scanned or otherwise interacted with by the user, the user is directed to a webpage (served by the Tag Element System) where the user can create and upload virtual content. The user-generated content that may be uploaded may consist of video, text, multimedia data, Uniform Resource Locators (URLs), streaming data, recorded information, retrieved information, and any other information that is created and/or referenced by the user. In addition to uploading existing content, the Tag Element System may permit the user to create new user-generated content prior to uploading.

Once the content is created, it is uploaded and saved in the cloud infrastructure, and available to view, download, or interact with via the same unique URL as before. The URL does not change, but its purpose does. Initially the URL is used for creating and uploading the content. After the content has been uploaded and saved, the URL is used for viewing, downloading, and/or interacting with the content. Currently, users who wish to distribute and link to virtual content in the physical world create their content first, then obtain a URL linking to that existing content. Users are required to find a provider to host their content (e.g., YouTube® for videos) or already have a publicly-facing web presence (e.g., a website) that displays that content and then must use a Naive Tag Element to link to it (e.g., a QR code pointing at a YouTube® page or website).

The Tag Element System creates the URLs first (accessible via a physical or digital Enhanced Tag Element), which allows users to upload whatever content they like when it is convenient for them. Users can even change which content is associated with an Enhanced Tag Element after the fact, without having to recreate, reprint, or change the tag element in any way. This is difficult or even impossible with existing hosting providers and Naive Tag Elements. In the above example, YouTube® does not allow users to change the video attached to a particular YouTube® URL after the fact. This means that a user would need to re-upload a video, get a new URL, and create a new Naive Tag Element (e.g., a new QR code) with that URL attached to it.

Also, because the content is created and hosted within the Tag Element System, the Tag Element System permits the end-user (i.e. the recipient of the content) to download the content onto their device, facilitating the complete creation and delivery of content from one user to another within the Tag Element System platform.

Additionally, when an Enhanced Tag Element has been received by a user as transmitted by the original user that has uploaded content, the receiving user may be provided with the ability to edit, modify, or update the content associated with the received Enhanced Tag Element. In this embodiment, the receiving user may be provided with a GUI to permit the receiving user to upload a different link, different video or multimedia content, written or text content, or other content to the received Enhanced Tag Element. Upon completion of the update of the received Enhanced Tag Element, the receiving user may then transmit the updated Enhanced Tag Element to one or more other persons and be directed to content, links, destinations, or other content that is different from (or supplemental to) the original user-generated content.

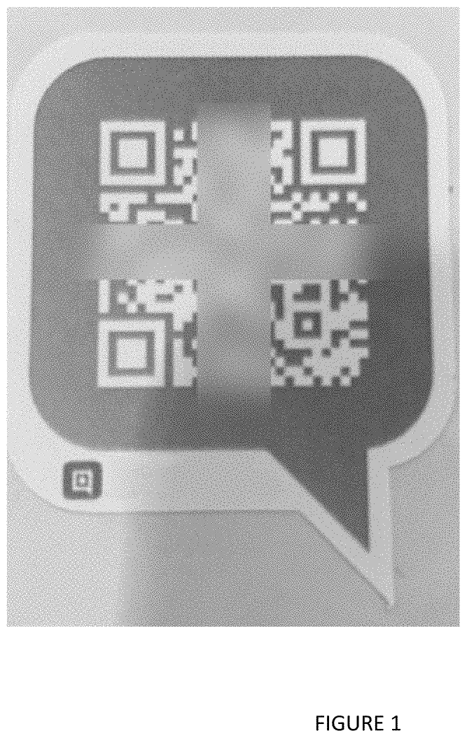

Turning now to FIG. 1, the figure shows a view of an exemplary Enhanced Tag Element 100 consistent with certain elements of the invention. Tag elements (Enhanced, as depicted in 100, or Naive), such as QR codes, NFC tags, RFID tags, or other such tag elements provide an ability for a user to scan the tag and receive information associated with the tag or be provided with a link to another source of information. Tag elements provide this direct link to other information or transmission to a site that provides information or an application for use. The figure presents a non-limiting example of an Enhanced Tag Element 100, represented as a QR code that has been blurred in this representative example. The Enhanced Tag Element 100 may be expressed in either a physical or electronic medium and may be provided to a user to scan or interact with in order to upload user generated-content.

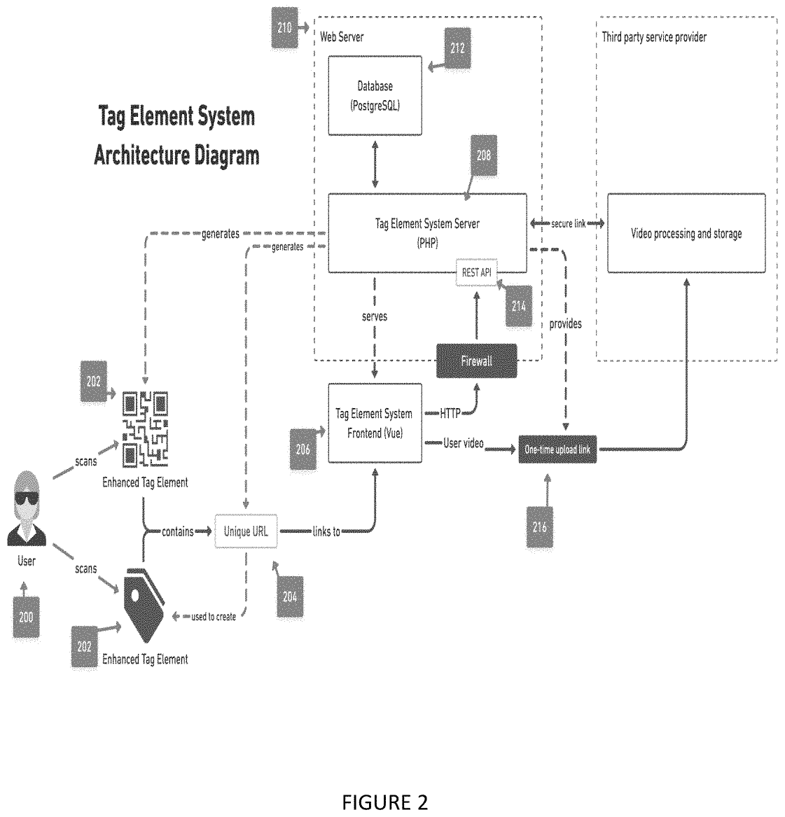

Turning now to FIG. 2, the figure presents a view of the Tag Element System architecture consistent with certain embodiments of the invention. In an embodiment a user 200 is provided with access to a pre-generated Enhanced Tag Element 202, where the tag element 202 may be a QR code, NFC tag, RFID tag, or any other electronic or physical tag element. The user 200 may scan the pre-generated Enhanced Tag Element 202 to scan a unique URL 204 from the Enhanced Tag Element 202.

The unique URL 204 links to and provides access to the Tag Element System Frontend 206, which presents the user 200 with a Graphical User Interface (GUI) to permit the entry and/or upload of content generated by the user 200. The GUI is managed and operated by the Tag Element System Server 208. The Tag Element System Server 208 is an element of a Web Server 210 that provides access to an electronic database 212, a REST API 214, and is protected by a firewall 218. The Tag Element System Server 208 receives input from the user 200 and stores the input and/or uploaded content to the internal electronic database 212 which stores information for later retrieval by the Tag Element System Server 208 and the Tag Element System Frontend 206. The Web Server 210 is protected and secured by a firewall 218 and provides access to a REST API 214 that enables the Tag Element System Frontend 206 to communicate with the Tag Element System Server 208. The REST API 214 may also create and share with the Tag Element System Frontend 206 a one-time upload link 216 to enable the Tag Element System Frontend 206 to upload user-generated content associated with an Enhanced Tag Element. In that case, the Tag Element System Server 208 stores a reference to the one-time upload link 216 on the database record for the Enhanced Tag Element 202 that was previously scanned by the user 200. This reference enables the Tag Element System Server to serve and embed user uploaded content at a later time, which provides the user 200 with the ability to scan a pre-generated Enhanced Tag Element 202, and access the Tag Element System Frontend 206, which connects to the Tag Element System Server 208 thru the REST API 214 in order to transfer or transmit the previously uploaded content to a second user. The uploaded user content of all types, including links and streaming video content, may be stored in electronic storage. The uploaded content may be stored and/or accessed via a third-party storage service by connecting over a secure link to a third-party storage provider, such as, in a non-limiting example, a cloud storage service provider, so as to present any streaming content to a user that has connected to the tag element web server 210 through scanning an Enhanced Tag Element 202.

When the newly repurposed Enhanced Tag Element is received by a second user, that user may scan the received Enhanced Tag Element 202. Upon scanning, the second user will be able to access the uploaded content, links, or streaming content that have been attached to the Enhanced Tag Element 202. In this manner, the second user will be provided with a completely different experience than the original user 200 and be based upon the content uploaded to the system by the original user 200.

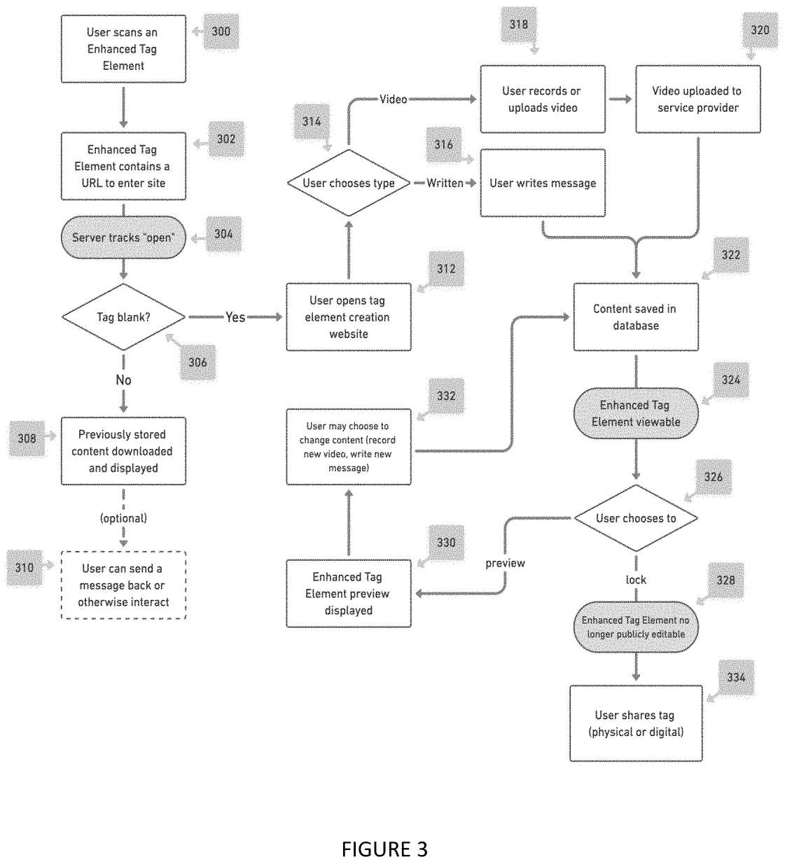

Turning now to FIG. 3, the figure presents a flow diagram view of the Tag Element System Processing consistent with certain embodiments of the invention. In an embodiment at 300 the user scans an Enhanced Tag Element to retrieve the content and/or link associated with the Tag. At 302 the user is presented with an Enhanced Tag Element that contains a URL to direct the user to the Tag Element System site. At 304, when the user accesses the URL and enters the Tag Element System site the Tag Element System server tracks the opening of the URL from the particular pre-generated Enhanced Tag Element that was used to navigate to the Tag Element System site. At 306 the Tag Element System Server determines if the Enhanced Tag Element is “blank”, meaning that there has been no user content uploaded to the Enhanced Tag Element associated with the URL.

If the Enhanced Tag Element has been loaded with content of any type from a previous interaction with a user the Tag Element System Server will retrieve any previously stored user uploaded content. The Tag Element System Server then displays the user-generated content to the user at 308 on a display device associated with the user. In a non-limiting example, the Tag Element System Server at 310 may permit the user that has scanned the Enhanced Tag Element to input a message that may be destined to be delivered to the user that originally provided the content that was associated by the Tag Element System Server to the Enhanced Tag Element. Optionally, additional interaction may be permitted such as uploading content from a subsequent user that may then modify, replace, or add to the content that was input and uploaded from any previous user. The Enhanced Tag Element may then be updated to download and display the newly uploaded user content when the URL associated with the Enhanced Tag Element is accessed and a different user navigates to the Tag Element System.

If the Enhanced Tag Element is blank at 306, the Tag Element System Server redirects the user to the Enhanced Tag Element creation webpage to permit input and/or upload of content by the user that has accessed the URL at 312. At 314, the user is presented with an option for the type of user content that the user wishes to upload and associated with the Enhanced Tag Element. The user may be provided with the option to input written, video, reference links, multimedia, or other types of content to be associated with the Enhanced Tag Element. If the user selects the option to input text or other written content the Tag Element System transfers the user to a GUI input display at 316, permitting the user to input or upload text information to the Tag Element System. If the user selects the option to input video or other multimedia content, the Tag Element System transfers the user to an input GUI that permits the user to record video content to the Tag Element System, or, alternatively, permits the user to upload video or multimedia content to the Tag Element System at 318. At 320, if the user has input or uploaded video or multimedia content, the Tag Element System at 320 uploads the received video or multimedia content to a server, such as a third-party server or a server upon which the Tag Element System resides, that will serve the content and provide access to the content as received. At 322 the Tag Element System stores all content, whether in text, written, video, multimedia, or link format to the Tag Element System electronic storage component and saves the content into a database for later retrieval.

Upon the completion of user content upload, in whatever form or format, the Tag Element System at 324 presents a view of the Enhanced Tag Element to the user. At 326 the Tag Element System provides the user with a preview of the Enhanced Tag Element and the user content associated with the Enhanced Tag Element. If the user is satisfied with the Enhanced Tag Element and the content that has been associated with the displayed Enhanced Tag Element, the system locks the Enhanced Tag Element at 328 to prevent further editing of the Enhanced Tag Element or of user content to be uploaded to be associated with the Enhanced Tag Element. If the user is not satisfied with the Enhanced Tag Element or the content most recently uploaded upon reviewing the Enhanced Tag Element and associated uploaded content at 330, the user may choose to change the content, in whatever format the uploaded content has been created, at 332. At this point the process returns to step 322 to save any newly created and uploaded content.

The user will have another opportunity to review the Enhanced Tag Element and any user content that has been created, uploaded, and associated with the Enhanced Tag Element at 326. Once again, upon acceptance by the user the Enhanced Tag Element may be locked by the Tag Element System at 328 and then the user may proceed to the dissemination of the Enhanced Tag Element. At 334, the Tag Element system informs the user that the Enhanced Tag Element creation process is complete and provides the user with the means to share the Enhanced Tag Element with one or more other persons to permit those recipients of the Enhanced Tag Element to be redirected to the user content that has been associated with the Enhanced Tag Element. Sharing the Enhanced Tag Element permits the Enhanced Tag Element to be the connection conduit through which one or more other persons may attach to and/or consume the user uploaded content.

In a non-limiting example, in future iterations of the Tag Element System the original user who first loaded user content to an Enhanced Tag Element may be provided with access to uploaded content stored within the Tag Element System to permit the original user to modify, edit, or otherwise change an Enhanced Tag Element. This permits the original user to change the Enhanced Tag Element either before transmitting the Enhanced Tag Element to the one or more persons, or after transmission to one or more persons the original user may modify the content associated with the Enhanced Tag Element and permit a newly created Enhanced Tag Element experience, as marked by new and different uploaded content, to be transmitted from the original user to one or more persons as before.

While certain illustrative embodiments have been described, it is evident that many alternatives, modifications, permutations and variations will become apparent to those skilled in the art in light of the foregoing description.

We claim:

1. A process for content transmission comprising
generating a tag element;
presenting said generated tag element to a first user;
collecting user-generated content from said first user;
associating said user-generated content with said generated tag element;
transmitting said generated tag element with said associated user generated content to a second user;
said second user accessing said first user-generated content from said tag element and permitting consumption of said first user-generated content upon access.

2. The process of claim 1 further comprising permitting said first user to transmit said tag element to multiple secondary users;

3. The process of claim 1 where the user-generated content comprises video, text, multimedia data, Uniform Resource Locators (URLs), streaming data, recorded information, retrieved information, and any other information that is uploaded and/or created by said user.

4. The process of claim 1 where the tag element comprises any of QR codes, NFC tags, RFID tags, or other such tag elements which the user interacts with and/or scans.

5. The process of claim 1 where user-generated content comprises previously stored content.

6. The process of claim 1 further comprising a graphical user input interface to collect user-generated content.

7. The process of claim 6 where the user-generated content input to said graphical user input interface is stored within an electronic storage medium.

8. The process of claim 6 where user-generated content and the association of said user-generated content with a previously-generated tag element is stored within an electronic storage medium.

9. A system for content transmission comprising
a data processor;
said data processor generating a tag element;
said data processor presenting said generated tag element to a first user;
said data processor generating a Graphical User Interface (GUI) and collecting user-generated content from said first user utilizing said GUI;
the data processor associating said user-generated content with said generated tag element;
transmitting said generated tag element with said associated user-generated content to a second user external to said data processor;
said second user connecting to said data processor and accessing said user-generated content from said tag element and permitting consumption of said user generated content upon access.

10. The system of claim 1 further comprising permitting said first user to transmit said tag element to multiple secondary users;

11. The system of claim 1 where the user-generated content comprises video, text, multimedia data, Uniform Resource Locators (URLs), streaming data, recorded information, retrieved information, and any other information that is uploaded and/or created by said user.

12. The system of claim 1 where the tag element comprises any of QR codes, NFC tags, RFID tags, or other such tag elements which the user interacts with and/or scans.

13. The system of claim 1 where user-generated content comprises previously stored content.

14. The system of claim 9 where the user-generated content input to said GUI interface is stored within an electronic storage medium.

15. The system of claim 9 where user-generated content and the association of said user-generated content with a previously generated tag element is stored within an electronic storage medium.
